(19) United States
(12) Patent Application Publication
(10) Pub. No.: US 2018/0099208 A1
(43) Pub. Date: Apr. 12, 2018

(54) Electric boards, related methods and power sources

(71) Applicant: Jeffrey Alan Mckinney, Lafayette, CA (US)

(72) Inventor: Jeffrey Alan Mckinney, Lafayette, CA (US)

(21) Appl. No.: 15/732,221

(22) Filed: Oct. 5, 2017

Related U.S. Application Data
(60) Provisional application No. 62/496,251, filed on Oct. 6, 2016.

(51) Int. Cl. A63C 17/12; A63C 17/01; B60L 11/18; H01M 4/485; H01M 10/0525

(52) U.S. Cl. CPC A63C 17/12; A63C 17/012; B60L 11/1877; B60L 11/1879; H01M 2004/027; H01M 10/0525; A63C 2203/12; A63C 17/015; H01M 4/485

(57) ABSTRACT

The present invention generally relates to two-wheel, three-wheel or four-wheel electric boards, methods of making and using the boards, and power sources used to propel the boards. In one aspect the present invention provides a two-wheel, three-wheel or four-wheel electric board. The board includes: at least one truck and one battery case attached to a deck; at least two wheels attached to the at least one truck; an electric motor operably connected to at least one wheel and electrically connected to the battery case, wherein there is at least one battery in the battery pack, and wherein the at least one battery comprises a lithium-titanate-based anode.

### FIELD OF THE INVENTION

The present invention generally relates to two-wheel, three-wheel or four-wheel electric boards, methods of making and using the boards, and power sources used to propel the boards.

### BACKGROUND OF THE INVENTION

There have been reports of electric boards. U.S. Pat. No. 9,387,388, for instance, is allegedly directed to the following invention: “Embodiments relate to a motorized skateboard. Embodiments allow users to utilize a power supply, such as a rechargeable battery pack, that is remote with respect to the skateboard. Embodiments can have the battery mounted on, under, partially or wholly enclosed within, and/or integral with the skateboard deck. Embodiments can have a removable and interchangeable motor mount, which attaches to the hanger to align the motor with the drive train. The drive wheel adaptor (hub) allows the user to modify standard skateboard wheels to use as drive wheels for the electric skateboard. The strength of the bond between the drive hub and the wheel enables the skateboard to utilize more torque without failure. Embodiments can allow users to have wiring connections at the front and/or back of the skateboard deck. Board-integrated wiring techniques can also be utilized. The electronics can be attached using brackets that fit the industry standard bolt pattern.” Abstract.

U.S. Pat. No. 8,061,725 is allegedly directed to the following invention: “A motorized skateboard (10) having an electric motor (102) that rotates a rear fifth drive wheel (86) that extends behind the rear truck (36) of the motorized skateboard (10). The drive wheel (86), which is biased downward by the force of gravity, interfaces with the surface of the ground. A hand-held cable assembly (140) having a power switch (142) controls the operation of the electric motor (102) which applies power to and causes the rear drive wheel (86) to rotate. The rotating drive wheel (86) further causes the motorized skateboard (10) to be propelled forward. The forward motion will continue as long as the rider depresses the power switch (142).” Abstract.

Despite these reports, there is still a need in the art for novel two-wheel, three-wheel or four-wheel electric boards, methods of making and using the boards, and power sources used to propel the boards.

### SUMMARY OF THE INVENTION

In one aspect the present invention provides a two-wheel, three-wheel or four-wheel electric board. The board includes: at least one truck and one battery case attached to a deck; at least two wheels attached to the at least one truck; an electric motor operably connected to at least one wheel and electrically connected to the battery case, wherein there is at least one battery in the battery pack, and wherein the at least one battery comprises a lithium-titanate-based anode.

### BRIEF DESCRIPTION OF THE DRAWINGS

FIG. 1 shows an embodiment of a four-wheel electric board according to the present invention.

### DETAILED DESCRIPTION OF THE INVENTION

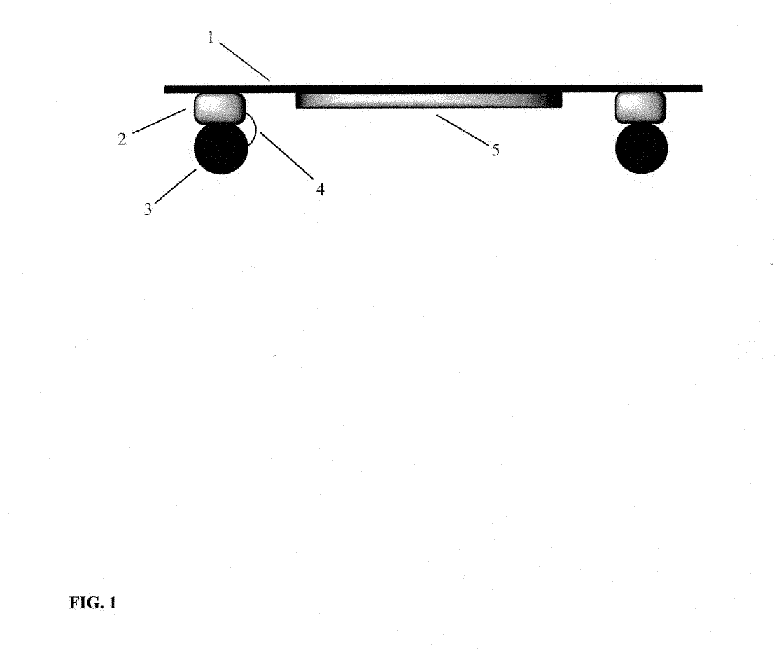

FIG. 1 shows an embodiment of a four-wheel electric board according to the present invention. Two trucks (2) and battery case 5 are attached to deck 1. Four wheels (3, only two shown), two at one end and two at the other, are attached to trucks 2. Electric motor 4 is attached to one of the trucks 2, and it is operably connected to at least one wheel (3). Battery case 5 is electrically connected to electric motor 4. Battery case 5 includes one or more batteries.

Batteries used in the present invention typically include a cathode, an anode, one or more solvents, one or more electrolytes, and a container. The batteries also typically include a separator. See, for example, US Pat. Appl. 2010/0239908, US Pat. Appl. 2011/0111307, US Pat. Appl. 2013/0157137, and US Pat. Appl. 2015/0002988, which are incorporated-by-reference into this document for all purposes.

An anode of the battery includes lithium titanate—Li₄Ti₅O₁₂. The lithium titanate may be of any suitable form—e.g., spinel—and any suitable surface area—e.g., <1 m²/g, >1 m²/g, >10 m²/g, >20 m²/g, >30 m²/g, >40 m²/g, >50 m²/g, >60 m²/g, >70 m²/g, >80 m²/g, >90 m²/g or >100 m²/g.

A cathode of the battery includes any suitable material or materials. Nonlimiting examples of materials are: lithium cobalt (LiCoO₂); lithium nickel cobalt aluminum oxide (LiNi_{0.8}Co_{0.15}Al_{0.05}O₂); lithium nickel manganese cobalt oxide (LiNi_{0.33}Mn_{0.33}Co_{0.33}O₂); lithium manganese oxide (LiMn₂O₄); lithium iron phosphate (LiFePO₄).

A solvent of the battery includes any suitable solvent or mixture of solvents. Nonlimiting examples of solvents are: dimethyl carbonate; ethylene carbonate; propylene carbonate; diethyl carbonate; ethylmethyl carbonate; benzene; fluorobenzene; 1,2-difluorobenzene; 1,3-difluorobenzene; 1,4-difluorobenzene; 1,2,3-trifluorobenzene; 1,2,4-trifluorobenzene; 1,2-diiodobenzene; 1,3-diiodobenzene; 1,4-diiodobenzene; 1,2,3-triiodobenzene; 1,2,4-triiodobenzene; toluene; fluorotoluene; 2,3-difluorotoluene; 2,4-difluorotoluene; 2,5-difluorotoluene; 2,3,4-trifluorotoluene; 2,3,5-trifluorotoluene; chlorotoluene; 2,3-dichlorotoluene; 2,4-dichlorotoluene; 2,5-dichlorotoluene; 2,3,4-trichlorotoluene; 2,3,5-trichlorotoluene; iodotoluene; 2,3-diiodotoluene; 2,4-diiodotoluene; 2,5-diiodotoluene; 2,3,4-triiodotoluene; 2,3,5-triiodotoluene; xylene; vinylene carbonate; difluoroethylene carbonate; chloroethylene carbonate; dichloroethylene carbonate; bromoethylene carbonate; dibromoethylene carbonate; nitroethylene carbonate; cyanoethylene carbonate; fluoroethylene carbonate.

An electrolyte of the battery includes any suitable material or materials. Nonlimiting examples of electrolytes are: LiPF₆; LiBF₄; LiSbF₆; LiAsF₆; LiN(SO₂C₂F₅)₂; Li(CF₃SO₂)₂N; LiN(SO₃C₂F₅)₂; LiC₄F₉SO₃; LiClO₄; LiAlO₂; LiAlCl₄; LiN(CₓF₂ₓ₊₁SO₂)(C₃F_{2y+1}SO₂), LiCl, LiI, and LiB(C₂O₄)₂.

In certain cases, the battery does not include electrolytes, or includes them at a level that is less than 90 percent, 80 percent, 70 percent, 60 percent, 50 percent, 40 percent, 30 percent, 20 percent or 10 percent the level used in a typical lithium ion battery (e.g., graphite anode).

In certain other cases, the battery includes less than 90 percent, 80 percent or 70 percent of the amount of solvent used in a typical lithium ion battery. In still other cases, the battery includes less than 90 percent, 80, percent, 70 percent, 60 percent, 50 percent, 40 percent, 30 percent, 20 percent or 10 percent that amount of ethylene carbonate or propylene carbonate used in a typical lithium ion battery.

The battery container is typically either cylindrical (e.g., metal can) or flat (i.e., prismatic).

The battery separator may be of any suitable material. Nonlimiting examples of materials include: nonwoven fibers such as cotton, nylon, polyesters and glass; polymer films such as polyethylene, polypropylene, poly(tetrafluoroethylene), and polyvinyl chloride; naturally occurring substances such as rubber, asbestos, and wood.

The two-wheel, three-wheel or four-wheel electric boards of the present invention have unique characteristics. The boards can be fully recharged (i.e., almost zero charge to almost one hundred percent charge) in less than 20 minutes, in less than 15 minutes, in less than 10 minutes or in less than 5 minutes. The boards will not go into catastrophic failure (e.g., flame, blow-up, etc.) even if battery case 5 is: shot with a 22 caliber rifle or a 55 caliber machine gun; heated to temperatures greater than 100 C or 125 C or 150 C or 175 C; smashed by application of force. The board will operate within specifications (e.g., 3 mile, 4 mile, 5 mile, 6 mile or 7 mile range) at temperatures below 0 C, −10 C, −20 C, −30 C or −40 C. The board will operate within specifications (e.g., 3 mile, 4 mile, 5 mile, 6 mile or 7 mile range) at temperatures above 40 C, 45 C, 50 C, 55 C or 60 C.

The boards according to the present invention permit certain activities, including certain business activities, not permitted by previously reported boards. Enhanced safety permits several to many boards (e.g., 3 to 10 or 3 to 15 or 3 to 20) to be stored and/or charged in a relatively small space (e.g., one cubic meter or two cubic meters or three cubic meters or four cubic meters or five cubic meters) without concern for catastrophic failure. The boards can be rented or used for delivery of goods in cold temperatures (e.g., below 0 C, −10 C, −20 C, −30 C or −40 C) or in high temperatures (e.g., above 100 C or 125 C or 150 C or 175 C).

1. A two-wheel, three-wheel or four-wheel electric board comprising: at least one truck and one battery case attached to a deck; at least two wheels attached to the at least one truck; an electric motor operably connected to at least one wheel and electrically connected to the battery case, wherein there is at least one battery in the battery pack, and wherein the at least one battery comprises a lithium-titanate-based anode.
